(19) United States
(12) Patent Application Publication
(10) Pub. No.: US 2006/0177764 A1
(43) Pub. Date: Aug. 10, 2006

(54) Positive-tone photosensitivity resin composition

(75) Inventors: Hsin-Ming Liao, Yunlin County (TW); Yu-Ming Chen, Pingjhen City (TW); Yen-Cheng Li, Sanchong City (TW)

Correspondence Address: BACON & THOMAS, PLLC, 625 SLATERS LANE, FOURTH FLOOR, ALEXANDRIA, VA, 22314, US

(73) Assignee: Everlight USA, Inc., Pineville, NC (US)

(21) Appl. No.: 11/188,530

(22) Filed: Jul. 26, 2005

(30) Foreign Application Priority Data
Feb. 5, 2005 (CN) 2005100079349

(51) Int. Cl. G03C 1/76

(52) U.S. Cl. 430/270.1

(57) ABSTRACT

The present invention provides a positive-tone photosensitivity resin composition comprising (A) an alkali-soluble acrylic resin, the alkali-soluble acrylic resin containing at least one structure unit selected from the group consisting of the following structure unit (1), structure unit (2), and structure unit (3), 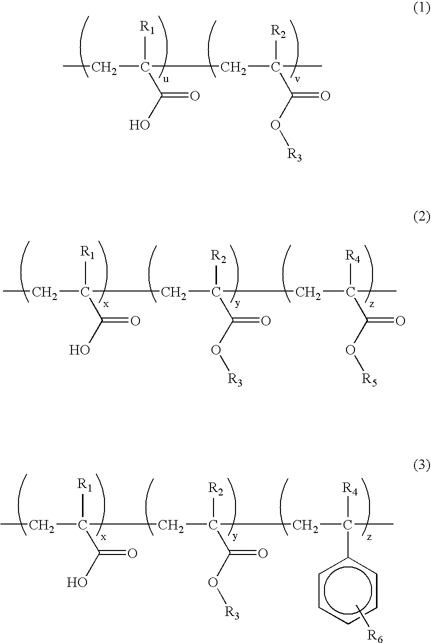
wherein R₁, R₂, R₃, R₄, R₅, R, U, V, X, Y and Z are defined the same as the specification; (B) a naphthoquinone-diazide group containing compound; and (C) an solvent, the solvent is selected from the group consisting of ethers, ketones, esters, aromatic hydrocarbons and acetoacetates.

### BACKGROUND OF THE INVENTION

1. Field of the Invention

The present invention relates to a resist composition and, more particularly, this invention relates to an alkali-developable positive-tone photosensitivity composition suited for microlithography such as print circuit board, flexible print circuit or the like.

2. Description of Related Art

Microlithography is a generic name for a technology which fabricates various precision parts, the technology including coating a radiation sensitive resin composition on an article to be processed patterning the coating film by photolithography, electroforming as by one or more of chemical etching, electrolytic etching or electroplating using the patterned film as a mask. The microlithography is a technology which is leading the current precision microprocessing techniques.

Conventional positive photoresist composition for ultraviolet high light mercury lamp lithography, compositions each comprising an alkali-soluble novolak resin and a naphthoquinone-diazide group containing compound and a solvent and other additives used as materials for forming resist, but the resist having poor toughness when coating on flexible substrates such as dip coating, roll coating, curtain coating, and spin coating may cause a problem that resist patterns are deformed or cracked. If cracked occur in the patterned film during etching, thereby causing a short circuit. However, conventional positive photoresist compositions do not satisfy all the required characteristics.

Japanese Patent application Laid-open No. 207057/1998 discloses a positive-tone photoresist composition which comprised acrylic resins in order to mainly improve the plating resistance. The technology just only can decrease occurrence of cracks. However, a large amount of acrylic resins added to inhibit cracks decreases the contrast as a resist and worsens the pattern shape.

### SUMMARY OF THE INVENTION

Other objects, advantages, and novel features of the invention will become more apparent from the following detailed description when taken in conjunction with the accompanying drawings.

The present invention provides a positive-tone photosensitivity resin composition comprising:

(A) 100 parts by weight of an alkali-soluble acrylic resin with a weight average molecule weight of 2000-300000, said alkali-soluble acrylic resin containing at least one structure unit selected from the group consisting of the following structure unit (1), structure unit (2) and structure unit (3), 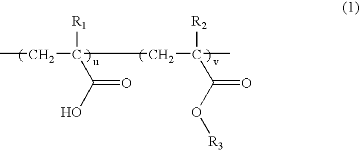
wherein R₁ is H, —CH₃, or —C₂H₅; R₂ is H, —CH₃, or —C₂H₅; R₃ is H, C₁-C₁₂ alkyl, C₄-C₁₂ cyclic alkyl or C₆-C₁₈ aromatic group; U>0, V>0, and U+V=1; 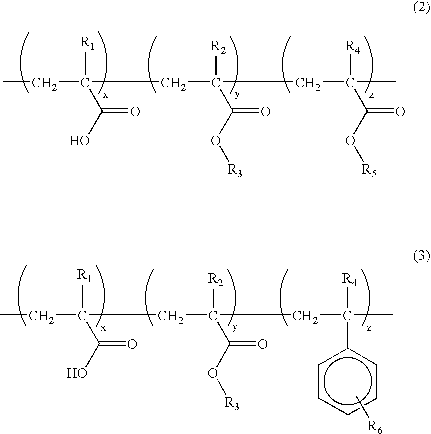
wherein R₁, R₂ and R₃ are defined the same as the above structure unit (1); R₄ is H, —CH₃, —C₂H₅; R₅ is C₁-CI2 alkyl, C₄-C₁₂ cyclic alkyl or C₆-C₁₈ aromatic group; R₆ is H, —CH₃, —C₂H₅; X>0, Y>0, Z>0, and X+Y+Z=1;

(B) 5 to 100 parts by weight of a naphthoquinone-diazide group containing compound, the amount of said naphthoquinone-diazide group containing compound is calculated by comparing with 100 parts by weight of said alkali-soluble acrylic resin of component (A); and

(C) 100 to 2000 parts by weight of a solvent, said solvent is selected from the group consisting of ethers, ketones, esters, aromatic hydrocarbons and acetoacetates, the amount of said solvent is calculated by comparing with 100 parts by weight of said alkali-soluble acrylic resin of component (A).

The positive-tone photosensitivity resin composition of the present invention has well toughness and non crack issue, having sharp images profile, also can be well coating uniformity to substrate, can be well developed with alkali developing solution, can be well stripped from substrates at the resist unexposured areas, and exhibits a sufficient resolution.

The aforementioned U and V of structure unit (1), preferably said U is 0.5 to 0.7, and said V is 0.95 to 0.3.

The aforementioned X, Y, and Z of structure unit (2), preferably said X is 0.05 to 0.7; Y is 0.90 to 0.05; and Z is 0.05 to 0.25.

The aforementioned R₃ of structure unit (1), preferably said R₃ is C₁-C₁₂ alkyl or C₄-C₁₂ cyclic alkyl.

The aforementioned R₃ and R₅ of structure unit (2), preferably said R₃ is C₁-C₁₂ alkyl; and said R₅ is C₁-C₁₂ alkyl.

The aforementioned R₃ and R₅ of structure unit (2), it is also preferred that R₃ is C₄-C₁₂ cyclic alkyl; and said R₅ is C₄-C₁₂ cyclic alkyl.

Preferably, the naphthoquinone-diazide group containing compound is an ester compound formed by reacting naphthoquinone-1,2-diazide-sulfonic acid with polyhydroxybenzophenone. More preferably, the naphthoquinone-diazide group containing compound is an ester compound formed by reacting naphthoquinone-1,2-diazide-sulfonic acid with 2,3,4-trihydroxybenzophenone, bis(4-hydroxy-2,5-dimethylphenyl)-3,4-dihydroxyphenylmethane, or 2,3,4,4′-tetrahydroxybenzophenone.

When the aforementioned solvents are ethers, preferably they are selected from ethylene glycol monomethyl ether, ethylene glycol monoethyl ether, ethylene glycol mono-n-propyl ether, ethylene glycol mono-n-butyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, propylene glycol mono-n-propyl ether, propylene glycol mono-n-butyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether and tripropylene glycol monoethyl ether, diethylene glycol dimethyl ether, diethylene glycol methyl ethyl ether, diethylene glycol diethyl ether, and tetrahydrofuran.

When the aforementioned solvents are ketones, prefereably they are selected from methyl ethyl ketone, cyclohexanone, 2-heptanone or 3-heptanone.

When the aforementioned solvents are esters, preferably they are selected from ethylene glycol monomethyl ether acetate, ethylene glycol monoethyl ether acetate, diethylene glycol monomethyl ether acetate, diethylene glycol monoethyl ether acetate, propylene glycol monomethyl ether acetate and propylene glycol monoethyl ether acetate, methyl 2-hydroxypropionate, ethyl 2-hydroxypropionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxyacetate, ethyl hydroxyacetate, methyl 2-hydroxy-3-methylbutyrate, 3-methyl-3-methoxybutyl acetate, 3-methyl-3-methoxybutyl propionate, ethyl acetate, n-propyl acetate, i-propyl acetate, n-butyl acetate, i-butyl acetate, n-amyl formate, i-amyl acetate, n-butyl propionate, ethyl butyrate, n-propyl butyrate, i-propyl butyrate, n-butyl butyrate, methyl pyruvate, ethyl pyruvate, n-propyl pyruvate, methyl acetoacetate, ethyl acetoacetate and ethyl 2-hydroxybutanoate.

When the aforementioned solvents are aromatics, preferably they are selected from toluene or xylene.

When the aforementioned solvents are amides, preferably they are selected from N-methylpyrrolidone, N,N-dimethylformamide and N,N-dimethylacetamide.

The alkali-developable positive-tone photosensitivity composition of the present invention further comprising (D) additives, wherein said additives are selected from: paints, dyes, thermal polymerization inhibitors, thickeners, antifoams, sensitizers and coupling agents. The said additives are known to one skilled in the art, and will not be further discussed.

The positive-tone photosensitivity resin composition of the present invention is coated on a print circuit of copper-clad substrate and it is then dried as a film for the fabrication of print circuit board. By selectively exposing activation rays to part of the film, thereafter developing the film with weak alkaline aqueous solution, an etching resistant film is obtained.

The copolymers of the present invention positive-tone photoresist composition have excellent coating and soften properties, where issues related to cracking of resist pattern are fully resolved. In addition other properties such as resolution, etching resistance, and ink removing properties also correspond to fine quality.

### DETAILED DESCRIPTION OF THE PREFERRED EMBODIMENT

The present invention provides a photosensitivity resin compositions comprising: (A) 100 parts by weight of an alkali-soluble acrylic resin with a weight average molecule weight of 2000-300000; (B) 5 to 100 parts by weight of a compound containing a quinonediazide group; and (C) 100 to 2000 parts by weight of a solvent.

The composition of the present invention will be described below in detail.

(A) Acrylic Resin

The alkali-soluble acrylic resin used in the present invention contain at least one structure unit selected from the group consisting of a unit of a radical-polymerizable compound having at least one carboxyl group and a unit of the other radical-polymerizable compound. In the present invention, “unit” indicates the structure unit formed in said alkali-soluble acrylic resin from the radical-polymerizable compound after the compound having undergone radical-polymerizable.

Here, the radical-polymerizable compound having at least one carboxyl group may be exemplified by monocarboxylic acids such as acrylic acid, methacrylic acid and crotonic acid; dicarboxylic acid such as maleic acid, fumaric acid, citroconic acid, mesaconic acid, itaconic acid; and methactylates having a carboxyl group, such as 2-maleinoyloxyethyl methacryltae, 2-succinoyloxyethyl methacrylate and 2-hexadrophthaloyloxyethyl acrylate; and preferably acrylic acid, methacrylic. Any of these compounds may be used alone or in combination of two or more.

The other radical-polymerizable compounds may be exemplified by: styrene, styrene substituted by α-methyl, o-alkyl, m-alkyl, p-alkyl, alkoxyl, halogen, nitro, cyano, amide, or ester; conjugated dienes such as butadiene, isoprene, chloropentadiene; (meth)acrylate; alkyl (meth)acrylates such as methyl (meth)acrylate, ethyl (meth)acrylate, n-propyl (meth)acrylate, iso-propyl (meth)acrylate, n-butyl (meth)acrylate, sec-butyl (meth)acrylate, tert-butyl (meth)acrylate, pentanyl (meth)acrylate, neo-pentanyl (meth)acrylate, iso-pentanyl (meth)acrylate, 2-ethyl hexyl acrylate, cyclo hexyl meth acrylate, adamantyl (meth)acrylate, propenyl (meth)acrylate, propynyl(meth)acrylate, phenyl (meth)acrylate, naphthyl (meth)acrylate, piperonyl (meth)acrylate, salicyl (meth)acrylate, cyclohexyl (meth)acrylate, benzyl (meth)acrylate, phenethyl (meth)acrylate, methylphenyl (meth)acrylate, epoxypropyl (meth)acrylate, tricyclo[5.2.1.0^{2,6}]dec-8-yl meth acrylate, and other monomers of like.

Among these other radical-polymerizable compounds, the preferred compounds are styrene, butadiene, phenyl (meth)acrylate, 2-ethyl hexyl acrylate, adamantyl (meth)acrylate, benzyl (meth)acrylate, tricyclo [5.2.1.0^{2,6}]dec-8-yl meth acrylate. These monomers may be used alone or used in combination of two or more. The copolymer ratio of other radical-polymerizable compounds is varied with the kinds of alkali-soluble acrylic resins which are used.

It is preferred that the copolymer ratio of radical-polymerizable compound having at least one carboxyl group ranges from 5 to 70% by weight, and more preferably 5 to 50% by weight. If while the aforementioned copolymer ratio is less than 5% by weight, the obtained composition may decrease the solubility of the alkali developing solution. If on the other hand, it is in an amount more than 70% by weight, the obtained composition has a much higher solubility and the resist pattern may easily be stripped off from the circuit board which can cause damages to the surface of the pattern.

The copolymer of the present invention is subjected to a gel permeation chromatography (GPC) solvent namely tetrahydrofuran (THF), generally the detected weight average molecular weight (Mw) of polystyrene is ranging from 1,000-500,000, and preferably 2,000-300,000.

With the use of alkaline soluble resins having similar Mw, a well-developed photoresist composition can be obtained, and from that specific pattern is obtained.

The copolymer of the present invention may be used alone or used in combination of 2 or more. Generally with a basis of 100 parts by weight, the copolymer of the present invention is used in an amount ranging from 3-80 parts by weight, and preferably 10-60 by weight.

(B) Naphthoquinone-diazide group Containing Compound

The component-(B) naphthoquinone-diazide group containing compound of the present invention has a structure wherein a hydroxyl group or amino group of the following compound (I) to (VI) and a carboxyl group of a naphthoquinonediazide group-containing sulfonic acid, such as naphthoquinone-1,2-diazide-5-sulfonic acid, and naphthoquinone-1,2-diazide-4-sulfonic acid have formed an ester linkage or amide linkage, and may include completely esterified products, partially esterified products, amidized products and partially amidized products of the compounds (I) to (VI).

(I) Polyhydroxybenzophenones such as: 2,3,4-trihydroxybenzo phenone, 2,4,4′-trihydroxybenzophenone, 2,4,6-trihydroxybenzophenone, 2,3,6-trihydroxybenzophenone, 2,3,4-trihydroxy-2′-methylbenzophenone, 2,3,4,4′-tetrahydroxybenzophenone, 2,2′,4,4′-tetrahydroxybenzophenone, 2,3′,4,4′,6-pentahydroxybenzophenone, 2,2,3,4,4′-pentahydroxybenzo phenone, 2,2′,3,4,5-pentahydroxybenzophenone, 2,3′,4,4′,5′,6-hexahydroxy benzophenone and 2,3,3′,4,4′,5′-hexahydroxybenzophenone;

(II) bis[(poly)hydroxyphenyl]alkanes such as: bis(2,4-dihydroxy phenyl)methane, bis(2,3,4-trihydroxyphenyl)methane, 2-(4-hydroxyphenyl)-2-(4′-hydroxyphenyl)propane, 2-(2,4-dihydroxyphenyl)-2-(2′,4′-dihydroxyphenyl)propane, 2-(2,3,4-trihydroxyphenyl)-2-(2′,3′,4′-trihydroxyphenyl)propane;

(III) tris (hydroxyphenyl)methanes and those a hydrogen atom of the benzene ring of which has been substituted with a methyl group (hereinafter “methyl-substituted products”), such as tris(4-hydroxyphenyl)methane, bis(4-hydroxy-3,5-dimethylphenyl)-4-hydroxyphenylmethane, bis(4-hydroxy-2,5-dimethylphenyl)-4-hydroxyphenylmethane, bis(4-hydroxy-3,5-dimethylphenyl)-2-hydroxyphenylmethane, bis(4-hydroxy-2,5-dimethylphenyl)-2-hydroxyphenylmethane, bis(4-hydroxy-2,5-dimethyl phenyl)-3,4-dihydroxyphenylmethane and bis(4-hydroxy-3,5-dimethylphenyl)-3,4-dihydroxyphenylmethane;

(IV) bis(cyclohexylhydroxyphenyl)(hydroxyphenyl) methanes and methyl-substituted products thereof such as bis(3-cyclohexyl-4-hydroxyphenyl)-3-hydroxyphenylmethane, bis(3-cyclohexyl-4-hydroxyphenyl)-2-hydroxyphenylmethane, bis(3-cyclohexyl-4-hydroxyphenyl)-4-hydroxyphenylmethane, bis(5-cyclohexyl-4-hydroxy-2-methylphenyl)-2-hydroxyphenylmethane, bis(5-cyclohexyl-4-hydroxy-2-methylphenyl)-3-hydroxyphenylmethane, bis(5-cyclohexyl-4-hydroxy-2-methylphenyl)-4-hydroxyphenylmethane, bis(3-cyclohexyl-2-hydroxyphenyl)-3-hydroxyphenylmethane, bis(5-cyclohexyl-4-hydroxy-3-methylphenyl)-4-hydroxyphenylmethane, bis(5-cyclohexyl-4-hydroxy-3-methylphenyl)-3-hydroxyphenylmethane, bis(5-cyclohexyl-4-hydroxy-3-methylphenyl)-2-hydroxyphenylmethane, bis(3-cyclohexyl-2-hydroxyphenyl)-4-hydroxyphenylmethane, bis(3-cyclohexyl-2-hydroxyphenyl)-2-hydroxyphenylmethane, bis(5-cyclohexyl-2-hydroxy-4-methylphenyl)-2-hydroxyphenylmethane and bis(5-cyclohexyl-2-hydroxy-4-methylphenyl)-4-hydroxyphenylmethane;

(V) aromatic compounds having a phenolic hydroxyl group or amino group, including phenol compounds such as phenol, p-methoxyphenol, dimethylphenol, hydroquinone, naphthol, pyrocatechol, pyrogallol and gallic acid; partially etherified compounds of polyphenol compounds, such as pyrogallol monomethyl ether and pyrogallol-1,3-dimethyl ether; aniline, p-aminodiphenylamine and 4,4′-diaminobenzophenone; and

(VI) novolak resins, pyrogallol-acetone resins, p-hydroxystyrene homopolymers, and copolymers of monomers copolymerizable with p-hydroxystyrene.

Preferred naphthoquinone-diazide group containing compounds are 2,3,4-trihydroxybenzophenone, 2,3,4,4′-tetrahydroxybenzophenone, 2,2′,3,4,4′-pentahydroxybenzophenone, 2-(4-hydroxyphenyl)-2-(4′-hydroxyphenyl)propane, 2-(2,3,4-trihydroxyphenyl)-2-(2′,3′,4′-trihydroxyphenyl)propane, tris(4-hydroxyphenyl)methane, bis(4-hydroxy-2,5-dimethylphenyl)-4-hydroxyphenylmethane and bis(4-hydroxy-2,5-dimethylphenyl)-2-hydroxyphenylmethane.

In the composition of the present invention, as the component (B), any of the above naphthoquinone-diazide group containing compounds may be used alone or in combination of two or more. This component-(B) may preferably be mixed in an amount ranging from 5 to 100 parts by weight, and more preferably from 10 to 60 parts by weight, based on 100 parts by weight of the component-(A) acrylic resin. If it is mixed in an amount less than 5 parts by weight, no images faithful to patterns can be obtained, resulting in a low transfer performance. If on the other hand it is in amount more than 100 parts by weight, the resist may have a very low sensitivity, undesirably.

(C) Solvent

The photoresist composition of the present invention utilizes the aforementioned composition (A) and (B) as the vital ingredient, and often a solvent is further added for the making of such liquid composition. The solvent is selected such that (A) and (B) are well dissolved with each other while with the compositions it is not reactive and has volatile properties. If the compositions (A) or (B) consisting of (D) additives, it is necessary for the additives (D) to be dissolved along with. The aforementioned solvent may be used alone or used in combination of 2 or more.

In addition, the preferable solvents are the same as the aforementioned. The aforementioned solvents can be used together with benzyl ether, hexyl ether, acetonitrile, acetone, isophorone, caprotic acid, heptanoic acid, 1-octyl alcohol,hydroxynaphthalene, hydroxyl benzyl, benzyl acrylate, ethyl benzoate, diethyl ethaneioate, diethyl maleate, γ-butyrolactone, ethylene carbonate, propylene carbonate, ethylene glycol methyl ether acetate and other high boiler solvents.

Among the high boiler solvents, γ-butyrolactone is preferred. The aforementioned high boiler solvents may be used alone or used in combination of two or more.

The total amount of solvents used is not critical, however various coating techniques are applicable to the photoresist composition, such as spin coating, spray coating, printing coating, roll coating, or dip coating, with varying cases the solvent ratio applied must be adjusted for fluidity as well as viscosity so that photoresist composition is well coated. In the overall composition of the present invention, as the solvent, the composition used is in an amount ranging from 5 to 90% by weight and preferably 20 to 80% by weight.

(D) Additives:

The additives used in the present invention are not critical. Basing on the photoresist, appropriate amount of sensitizers, dissolution inhibitors, surfactants, dyes, pigments, colorants, anti-oxidants, and other elastomers are added selectively. The obtained photoresist will satisfy the set requirements and standards; generally the total amount of additives added is less than 5 weight percent of the whole.

The description of the present invention will be described below with the following examples, it is to be understood that many other possible modifications and variations can be made without departing form the spirit and scope of the invention hereinafter claimed.

Quantities “parts” and “%” are given in weight if there is no indication.

The preparation examples 1 to 6 below are related to the preparation of component (A).

### PREPARATION EXAMPLE 1

The inside of a flask provided with a dry ice/methanol reflux condenser and a thermometer was replaced by nitrogen, and thereafter 3.0 g of 2,2′-azobisbutyronitrile as a polymerization initiator and 225 g of ethyl 2-hydroxypropionate were charged into it, followed by stirring until the polymerization initiator dissolved. Subsequently, 60 g of benzyl methacrylate, 40.0 g of methacrylic acid were charged, followed by gentle stirring. Thereafter, the temperature of the solution was raised to 80 degree C., and polymerization was carried out at this temperature for 4 hours. Thereafter, the reaction mixture was cooled to room temperature, and the inside of the flask was replaced by the air, followed by addition of 150 mg of p-methoxyphenol as a stabilizing agent. The reaction product was dropwise added in a large quantity of methanol to settle acrylic resin. The sediment thus obtained was washed with water, and thereafter dissolved in tetrahydrofuran with the same weight, followed by sedimentation was again carried out in a large quantity of methanol. This procedure of re-dissolution and sedimentation was carried out three times in total, and thereafter the sediment obtained was vacuum-dried at 40 degree C. for 48 hours to obtain acrylic resin A1.

### PREPARATION EXAMPLE 2

The same procedure of Synthesis Example 1 was repeated except that the starting material monomers were replaced with 20.0 g of methacrylic acid, 70.0 g of methyl methacrylate and 10.0 g of 2-ethyl hexyl acrylate. Thus, acrylic resin A2 was obtained.

### PREPARATION EXAMPLE 3

The same procedure of Synthesis Example 1 was repeated except that the starting material monomers were replaced with 30.0 g of 2-hydroxyethyl acrylate, 90.0 g of styrene and 30.0 g of methacrylic acid. Thus, acrylic resin A3 was obtained.

### PREPARATION EXAMPLE 4

The same procedure of Synthesis Example 1 was repeated except that the starting material monomers were replaced with 40.0 g of 2-hydroxyethyl acrylate, 80.0 g of methyl methacrylate and 30.0 g of methacrylic acid. Thus, acrylic resin A4 was obtained.

### PREPARATION EXAMPLE 5

The same procedure of Synthesis Example 1 was repeated except that the starting material monomers were replaced with 30.0 g of dicyclopentanyl methacrylate, 90.0 g of n-butyl acrylate and 30.0 g of methacrylic acid. Thus, acrylic resin A5 was obtained.

### PREPARATION EXAMPLE 6

The same procedure of Synthesis Example 1 was repeated except that the starting material monomers were replaced with 30.0 g of 2-adamantyl methacrylate, 90.0 g of ethyl acrylate and 30.0 g of methacrylic acid. Thus, acrylic resin A6 was obtained.

(B) naphthoquinone-diazide group containing compounds were supplied and purchased from ToYo GoSei Co., Ltd. (B 1): 2,3,4-trihydroxybenzophenone-naphthoquinone-1,2-diazide-5- sulfonic ester. (B2): bis(4-hydroxy-2,5-dimethylphenyl)-3,4-dihydroxyphenyl methane-naphthoquinone-1,2-diazide-5-sulfonic ester. (B3): 2,2′,4,4′-tetrahydroxybenzophenone-naphthoquinone-1,2-diazide-5-sulfonic ester.

The examples 1 to 10 described below were the preparation of the photoresist composition of the present invention.

### EXAMPLE 1

Mixed completely 100 g of acrylic resin (A1) prepared in preparation example 1, 20 g of (B1) naphthoquinone-diazide group containing compound, and 150 g of (C) propylene glycol monoethyl ether acetate. The resultant solution was filtered using a membrane filter of 10 μm in pore size. Thus, a positive photoresist comparative composition was prepared.

### EXAMPLE 2 TO 10

The same procedure of example 1 was repeated except that (A) acrylic resin and (B) naphthoquinone-diazide group containing compound were replaced with different compound of the same group as shown in table 1. The photoresist composition was prepared with the same procedure and the amount added to was unchanged

TABLE 1

| | | (B) Naphthoquinone-diazide |
|---|---|---|
| Examples | (A) Acrylic Resin | group containing compound |
| Example 2 | A2 | B1 |
| Example 3 | A3 | B1 |
| Example 4 | A4 | B1 |
| Example 5 | A5 | B3 |
| Example 6 | A6 | B3 |
| Example 7 | A2 | B2 |
| Example 8 | A2 | B3 |
| Example 9 | A5 | B2 |
| Example 10 | A6 | B2 |

### COMPARATIVE EXAMPLE 1

The 100 g of novolak resin that synthesis by 100 g of m-cresol, 100 g 10 of p-cresol, 120 g of 37% formalin, and the average molecular weight is 7000. And mixed 20 g of naphthoquinone-diazide group containing compound as B1, thereafter dissolved in a solvent of 150 parts propylene glycol monoethyl ether acetate. The resultant solution was filtered using a membrane filter of 10 μm in pore size. Thus, a positive photoresist comparative composition was prepared.

### COMPARATIVE EXAMPLE 2

Resist composition were prepared in the same manner as in comparative example 1 expect that extra added 50 g the acrylic resin of A2.

Thus, a comparative resist example 2 was prepared.

Evaluation of Properties

(1) Compatibility

The above positive photoresist composition was stirred at room temperature for 24 hours to carry out mixing, and its state immediately after stirring and upon leaving for 30 days after completion of the stirring was visually observed. How it stood was evaluated according to the following criteria:

◯: The composition was seen to have been uniformly dissolved immediately after stirring, and also seen to be in the uniformly dissolved state even after 30 days.

Δ: The composition was seen to have been uniformly dissolved immediately after stirring, but seen to have caused phase separation after 30 days.

X: The composition was not in the uniformly dissolved state on 24 hours after stirring.

(2) Uniformity

A given photosensitivity resist composition was applied in a copper-clad substrate throughout the entire surface thereof by roller coating and the applied layer of the sample was dried at 80° C for 10 min to form a film. The surface of the dry film formed was visually observed to evaluate coating properties according to the follow criteria:

◯: The film formed is free of unevenness and its uniform.

X: The film formed has unevenness such as pinhole or fish eye.

(3) Crack Test

A given photosensitivity resist composition was applied in a flexible print circuit of polyimide copper-clad substrate throughout the entire surface thereof by roller coating and the applied layer of the sample was dried at 80° C. for 10 min to form a film. The substrate was rolled on a cylinder that diameter equal to 15 cm after 24 hours. Then, checked the surface of the dry film formed was observed by SEM to evaluate crack properties according to the follow criteria:

◯: The film formed is non cracks and smoothly.

Δ: Slight cracking was observed on the pattern products.

X: The film formed has cracks all over the pattern products.

(4 ) Shape of Pattern

The substrate was exposed to ultraviolet high light mercury lamp according to a prescribed pattern through a pattern mask and then developed with an alkaline aqueous solution (1 wt % Na₂CO₃) to form a pattern. The lateral wall of the film on the substrate was observed by SEM (Scanning Electron Microscope) and the results of this observation were rated on the following scale.

◯: Perfect and sharp linear pattern in the wall.

Δ: Slight footing pattern observed in the wall.

X: No linear pattern obtained.

(5) Etching Resistance

The substrate having the pattern product formed in the lithography, and then etched using conventional acid cupric chloride etchant at 50 degree C., and thereafter washed with pure water to clean the substrate. The surface of the test substrate was visually observed on SEM to make evaluation according to the follow criteria.

◯: Residues good pattern product on substrate.

X: Non residues any copper-clad on substrate.

(6) Strippability

The substrate having the pattern product after etching process, and was immersion in a stripping alkaline aqueous solution (5 wt % NaOH) at room temperature, and thereafter washed with pure water to strip the pattern product. The surface of the test substrate was visually observed on SEM to make evaluation according to the follow criteria.

◯: Non residues of the pattern product are seen on the substrate.

X: Residues of the pattern product are seen on the substrate.

TABLE 2

| | | | | Crack | Shape of | Etching | |
|---|---|---|---|---|---|---|---|
| | | Compatibility | Uniformity | Test | pattern | Resistance | Strippability |
| Example | 1 | ◯ | ◯ | ◯ | ◯ | ◯ | ◯ |
| | 2 | ◯ | ◯ | ◯ | ◯ | ◯ | ◯ |
| | 3 | ◯ | ◯ | ◯ | ◯ | ◯ | ◯ |
| | 4 | ◯ | ◯ | ◯ | ◯ | ◯ | ◯ |
| | 5 | ◯ | ◯ | ◯ | ◯ | ◯ | ◯ |
| | 6 | ◯ | ◯ | ◯ | ◯ | ◯ | ◯ |
| | 7 | ◯ | ◯ | ◯ | ◯ | ◯ | ◯ |
| | 8 | ◯ | ◯ | ◯ | ◯ | ◯ | ◯ |
| | 9 | ◯ | ◯ | ◯ | ◯ | ◯ | ◯ |
| | 10 | ◯ | ◯ | ◯ | ◯ | ◯ | ◯ |
| Comparative | 1 | ◯ | ◯ | X | ◯ | ◯ | ◯ |
| Example | 2 | ◯ | ◯ | Δ | ◯ | ◯ | ◯ |

From the foregoing description, one skilled in the art can easily ascertain the essential characteristics of this invention and without departing from the scope thereof, one can make various changes and modifications of the invention to adapt it to various usages and conditions. Thus, other embodiments are also within the claims.

What is claimed is:

1. A positive-tone photosensitivity resin composition, which comprises:
(A) 100 parts by weight of an alkali-soluble acrylic resin with a weight average molecule weight of 2000-300000, said alkali-soluble acrylic resin containing at least one structure unit selected from the group consisting of the following structure unit (1), structure unit (2) and structure unit (3), 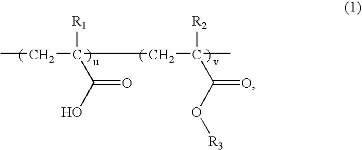
wherein R₁ is H, —CH₃, or —C₂H₅; R₂ is H, —CH₃, or —C₂H₅; R₃ is H, C₁-C₁₂ alkyl, C₄-C₁₂ cyclic alkyl or C₆-C₁₈ aromatic group; U>0, V>0, and U+V=1; 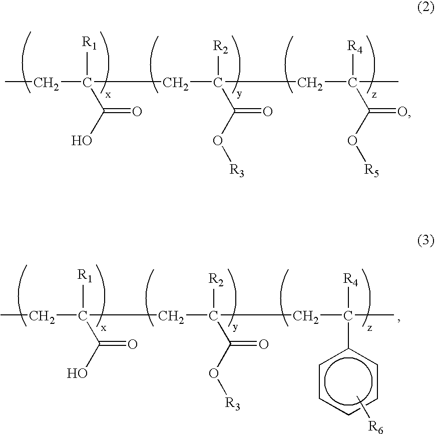
wherein R₁, R₂ and R₃ are defined the same as the above structure unit (1); R₄ is H, —CH₃, —C₂H₅; R₅ is C₁-C₁₂ alkyl, C₄-C₁₂ cyclic alkyl or C₆-C₁₈ aromatic group; R₆ is H, —CH₃, —C₂H₅; X>0, Y>0, Z>0, and X+Y+Z
(B) 5 to 100 parts by weight of a naphthoquinone-diazide group containing compound, the amount of said naphthoquinone-diazide group containing compound is calculated by comparing with 100 parts by weight of said alkali-soluble acrylic resin of component (A); and
(C) 100 to 2000 parts by weight of a solvent, said solvent is selected from the group consisting of ethers, ketones, esters, aromatic hydrocarbons and acetoacetates, the amount of said solvent is calculated by comparing with 100 parts by weight of said alkali-soluble acrylic resin of component (A).

2. The composition of claim 1, wherein said U is between 0.05 and 0.7, V is between 0.95 and 0.3.

3. The composition of claim 1, wherein said x is between 0.05 to 0.7; y is between 0.90 to 0.05; and Z is between 0.05 to 0.25.

4. The composition of claim 1, wherein said R₃ is C₁-C₁₂ alkyl.

5. The composition of claim 1, wherein said R₃ is C₄-C₁₂ cyclic alkyl.

6. The composition of claim 1, wherein said R₃ is C-C₁₂ alkyl; and the said R₅ is C₁-C₁₂ alkyl.

7. The composition of claim 1, wherein said R₃ is C₄-C₁₂ cyclic alkyl; and said R₅ is C₄-C₁₂ cyclic alkyl.

8. The composition of claim 1, wherein said naphthoquinone-diazide group containing compound is an ester compound formed by reacting naphthoquinone-1,2-diazide-sulfonic acid with polyhydroxybenzophenone.

9. The composition of claim 1, wherein said naphthoquinone-diazide group containing compound is an ester compound formed by reacting naphthoquinone-1,2-diazide-sulfonic acid with 2,3,4-trihydroxybenzophenone, bis(4-hydroxy-2,5-dimethylphenyl)-3,4-dihydroxyphenylmethane, or 2,3,4,4′-tetrahydroxybenzophenone.

10. The composition of claim 1, wherein said solvents are ethers, and said ethers are selected from the group consisting of ethylene glycol monomethyl ether, ethylene glycol monoethyl ether, ethylene glycol mono-n-propyl ether, ethylene glycol mono-n-butyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, propylene glycol mono-n-propyl ether, propylene glycol mono-n-butyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether and tripropylene glycol monoethyl ether, diethylene glycol dimethyl ether, diethylene glycol methyl ethyl ether, diethylene glycol diethyl ether, and tetrahydrofuran.

11. The composition of claim 1, wherein said solvents are ketones, and said ketones are selected from the group consisting of methyl ethyl ketone, cyclohexanone, 2-heptanone and 3-heptanone.

12. The composition of claim 1, wherein said solvents are esters, and said esters are selected from the group consisting of ethylene glycol monomethyl ether acetate, ethylene glycol monoethyl ether acetate, diethylene glycol monomethyl ether acetate, diethylene glycol monoethyl ether acetate, propylene glycol monomethyl ether acetate and propylene glycol monoethyl ether acetate, methyl 2-hydroxypropionate, ethyl 2-hydroxypropionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxyacetate, ethyl hydroxyacetate, methyl 2-hydroxy-3-methylbutyrate, 3-methyl-3-methoxybutyl acetate, 3-methyl-3-methoxybutyl propionate, ethyl acetate, n-propyl acetate, i-propyl acetate, n-butyl acetate, i-butyl acetate, n-amyl formate, i-amyl acetate, n-butyl propionate, ethyl butyrate, n-propyl butyrate, i-propyl butyrate, n-butyl butyrate, methyl pyruvate, ethyl pyruvate, n-propyl pyruvate, methyl acetoacetate, ethyl acetoacetate and ethyl 2-hydroxybutanoate.

13. The composition of claim 1, wherein said solvents are aromatic hydrocarbons, and said aromatic hydrocarbons are selected from the group consisting of: toluene and xylene.

14. The composition of claim 1, wherein said solvents are amides, and said amides are selected from the group consisting of N-methylpyrrolidone, N, N-dimethylformamide and N,N-dimethylacetamide.
